(19) United States
(12) Patent Application Publication
(10) Pub. No.: US 2025/0024422 A1
(43) Pub. Date: Jan. 16, 2025

(54) LOCATION REPORTING PROCEDURES COMPRISING HEIGHT INFORMATION FOR AERIAL USER EQUIPMENT

(71) Applicant: QUALCOMM Incorporated, San Diego, CA (US)

(72) Inventors: Chiranjib SAHA, Lakeside, CA (US); Umesh PHUYAL, San Diego, CA (US); Sunghoon KIM, San Diego, CA (US); Stefano FACCIN, San Ysidro, CA (US); Haris ZISIMOPOULOS, London (GB); Le LIU, San Jose, CA (US)

(21) Appl. No.: 18/708,764

(22) PCT Filed: Jan. 4, 2023
(86) PCT No.: PCT/US2023/060097

§ 371 Date: May 9, 2024

(30) Foreign Application Priority Data
Jan. 5, 2022 (GR) 20220100004

(51) Int. Cl. H04W 64/00; H04W 24/10

(52) U.S. Cl. CPC H04W 64/003; H04W 24/10

(57) ABSTRACT

Certain aspects of the present disclosure relate to methods and apparatus for enhancing location reporting procedures to include height information of a user equipment (UE), such as an aerial UE. The location reporting procedures may be between a core network entity and an access network entity. Due to the differences in coverage regions between areal cells and terrestrial cells, aerial UEs may not fully rely on cell identifiers (IDs) as a primary location indicator due to its ambiguity (e.g., as the aerial UEs may use a side-lobe or up-tilted beam of a far-away cell that provides a cell ID while its conventional geographical location belongs to another, closer cell). Aspects of the present disclosure provides techniques for enhancing the location reporting procedures for the aerial UEs to prevent such potential errors in location reporting.

### CROSS-REFERENCE TO RELATED APPLICATIONS

This application claims priority to GR Patent Application No. 20220100004, filed Jan. 5, 2022, which is assigned to the assignee hereof and hereby expressly incorporated by reference in its entirety as if fully set forth below and for all applicable purposes.

### FIELD

The present disclosure relates generally to communication systems, and more particularly, to methods and apparatus for location reporting procedures in wireless communications systems operating according to new radio (NR) technologies.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include Long Term Evolution (LTE) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In some examples, a wireless multiple-access communication system may include a number of base stations, each simultaneously supporting communication for multiple communication devices, otherwise known as user equipment (UEs). In LTE or LTE-A network, a set of one or more base stations may define an eNodeB (eNB). In other examples (e.g., in a next generation or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., a new radio base station (NR BS), a new radio node-B (NR NB), a network node, 5G NB, eNB, etc.). A base station or DU may communicate with a set of UEs on downlink channels (e.g., for transmissions from a base station or to a UE) and uplink channels (e.g., for transmissions from a UE to a base station or distributed unit).

These multiple access technologies have been adopted in various telecommunication standards to provide a common protocol that enables different wireless devices to communicate on a municipal, national, regional, and even global level. An example of an emerging telecommunication standard is new radio (NR), for example, 5G radio access. NR is a set of enhancements to the LTE mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL) as well as support beamforming, multiple-input multiple-output (MIMO) antenna technology, and carrier aggregation.

However, as the demand for mobile broadband access continues to increase, there exists a need for further improvements in NR technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims, which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure generally relate to methods and apparatus for enhancing location reporting procedures to include height information of a user equipment (UE), such as an aerial UE. The location reporting procedures may be between a core network entity (a first network entity) and an access network entity (a second network entity). Due to the differences in coverage regions between areal cells and terrestrial cells, aerial UEs may not fully rely on cell identifiers (IDs) and may incorrectly report their locations (e.g., as the aerial UEs may use a side-lobe or up-tilted beam of a far-away cell that provides a wrong cell ID). Aspects of the present disclosure provides techniques for enhancing the location reporting procedures for the aerial UEs to prevent such potential errors in location reporting.

Certain aspects provide a method of wireless communications for a first network entity. The method generally includes transmitting, to a second network entity, a request for a location report of a UE; and receiving, from the second network entity, the location report including height information of the UE.

Certain aspects provide a method of wireless communication for a second network entity. The method generally includes receiving, from a first network entity, a request for a location report of a UE; and transmitting, to the first network entity, the location report including height information of the UE.

Aspects generally include methods, apparatus, systems, computer readable mediums, and processing systems, as substantially described herein with reference to and as illustrated by the accompanying drawings.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIGS. 2A-2D are block diagrams illustrating example logical architectures of RANs, in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example BS and user equipment (UE), in accordance with certain aspects of the present disclosure.

FIG. 5 is a diagram showing examples for implementing a communication protocol stack, in accordance with certain aspects of the present disclosure.

FIGS. 6A and 6B illustrate example models of connection management states.

FIG. 7 illustrates an example of a DL-centric subframe, in accordance with certain aspects of the present disclosure.

FIG. 8 illustrates an example of an UL-centric subframe, in accordance with certain aspects of the present disclosure.

FIG. 9 illustrates an example location reporting procedure, in accordance with certain aspects of the present disclosure.

FIG. 10 illustrates example cells supporting aerial coverage, in accordance with certain aspects of the present disclosure.

FIG. 11 illustrates example operations for wireless communications by a first network entity, in accordance with certain aspects of the present disclosure.

FIG. 12 illustrates example operations for wireless communications by a second network entity, in accordance with certain aspects of the present disclosure.

FIG. 13 illustrates an example information element for location reporting with height information, in accordance with certain aspects of the present disclosure.

FIG. 14 illustrates an example information element for an area of interest, in accordance with certain aspects of the present disclosure.

FIG. 15 illustrates an example information element for an event type, in accordance with certain aspects of the present disclosure.

FIGS. 16 and 17 illustrate aspects of example communications devices, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for enhancing location reporting procedures to include height information of a user equipment (UE), such as an aerial UE. An aerial UE may be a UE that has more vertical mobility than conventional UEs, such as in terms of range and likelihood of changes. For example, an aerial UE may be an airborne UE, such as an unmanned aerial vehicle (UAV), or may be a UE onboard an aerial vehicle, such as a helicopter or an air transport.

The location reporting procedures may be between a core network entity and an access network entity. Due to the differences in coverage regions between areal cells and terrestrial cells, aerial UEs may not fully rely on cell identifiers (IDs) and may incorrectly report their locations (e.g., as the aerial UEs may use a side-lobe or up-tilted beam of a far-away cell that provides a wrong cell ID). Aspects of the present disclosure provides techniques for enhancing the location reporting procedures for the aerial UEs to prevent such potential errors in location reporting and to include height information.

There is a need for location determination and reporting that consider the height of a UE. At present, UAVs may not address the location determination functions used in radio resource control (RRC) for cell measurements or Location Reporting Control required for regulatory purposes, such as emergency calls or Lawful Access support and the use of Location Reporting primitives used by Location Services. For example, an emergency call from a UE located in an aerial vehicle (e.g., a helicopter, an airplane, or a drone taxi) may require accurate location reporting that includes height information. Similarly, location services for asset tracking for packages that are transported by UAVs may also benefit from accurate location reporting. Lawful access, such as in the case of a drone taxi, may also require location information including height information for compliance with national regulations.

Using cell ID alone as the location identifier, however, may not be accurate due to the change of altitude of such UEs. For example, at certain heights, the side-lobe coverage by a faraway or distant cell may provide better signal strength to the UE. That is, a UE may be served by a cell different than the cell that would have served the UE had the UE be closer to the ground than the current height. As a result, the UE may use the cell ID of the neighboring cell in the location report. This cell ID may cause ambiguity because other geographical location reporting based on the cell ID often assumes a ground level location reporting when the cell ID of the serving cell may represent the UE's location.

Aspects of the present disclosure provide techniques for accurately determining and reporting a UE location that may be affected by the height of the UE, so that the UE location (corresponding to a serving cell ID) may be determined accurately and avoiding potential ambiguity mentioned above. As described herein, the location reporting procedures may be enhanced by providing height information in addition to other aspects of location reporting, including in the response to a location reporting request. The location reporting may also indicate an area of interest, or indicate a new event type associated with height information. As such, the aforementioned use cases that benefit from the aerial UE's height information can be realized or supported.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method, which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication networks such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as New Radio (NR) (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

NR is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

NR may support various wireless communication services, such as Enhanced mobile broadband (eMBB) targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC). These services may include latency and reliability requirements. These services may also have different transmission time intervals (TTI) to meet respective quality of service (QoS) requirements. In addition, these services may co-exist in the same subframe.

### Example Wireless Communications System

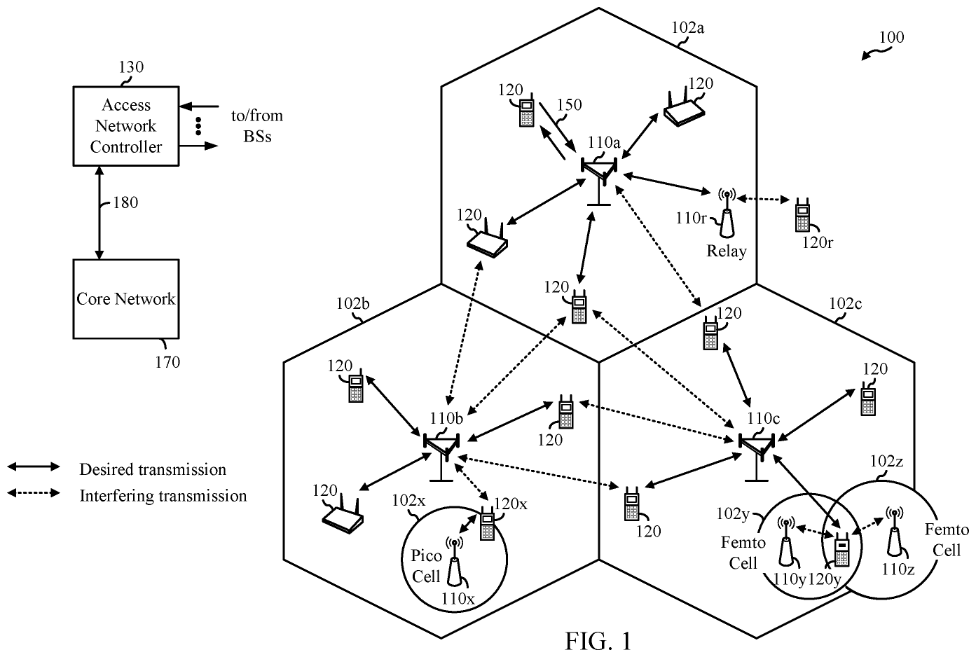

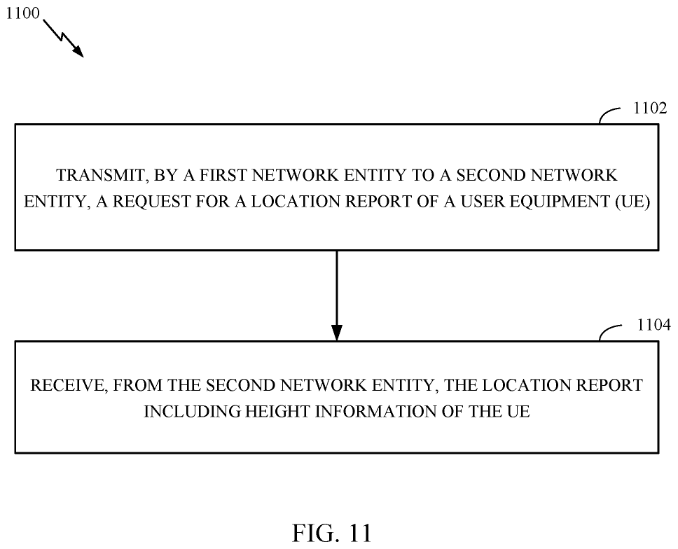

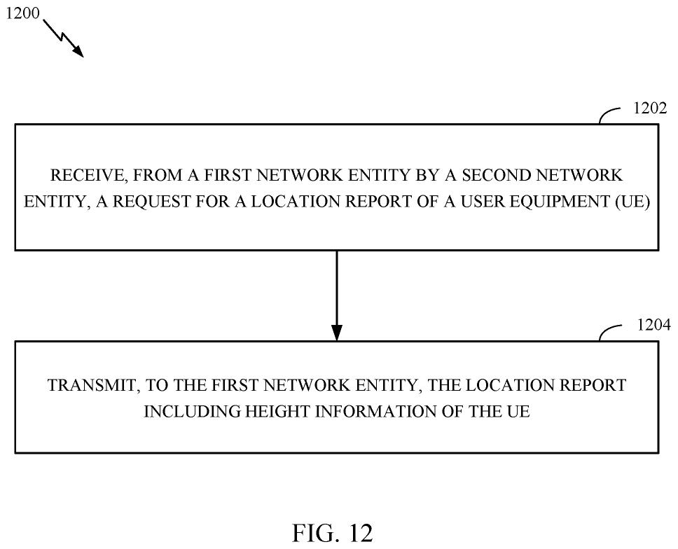

FIG. 1 illustrates an example wireless network 100, such as a new radio (NR) or 5G network, in which aspects of the present disclosure may be performed, for example, for providing location reporting with height information, as described in details below with reference to FIGS. 11-15. For example, a core network function 170 (e.g., an access and mobility management function (AMF)) may perform the operations of sending a request 180 (e.g., possibly via a network controller 130) for a location report of a user equipment (UE) 120, and receiving the location report that includes height information of the UE 120, as described in more detail with reference to FIG. 11. In another example, the base station (BS) 110 (or any general radio access network (RAN)) may perform the operations of receiving a request 150 for a location report of a UE, and sending the location report including height information to the AMF, as described in more detail with reference to FIG. 12.

As illustrated in FIG. 1, the wireless network 100 may include a number of BSs 110 and other network entities. A BS may be a station that communicates with UEs. Each BS 110 may provide communication coverage for a particular geographic area. In 3GPP, the term “cell” can refer to a coverage area of a Node B and/or a Node B subsystem serving this coverage area, depending on the context in which the term is used. In NR systems, the term “cell” and eNB, Node B, 5G NB, AP, NR BS, NR BS, or TRP may be interchangeable. In some examples, a cell may not necessarily be stationary, and the geographic area of the cell may move according to the location of a mobile base station. In some examples, the base stations may be interconnected to one another and/or to one or more other base stations or network nodes (not shown) in the wireless network 100 through various types of backhaul interfaces such as a direct physical connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BS for the femto cells 102y and 102z, respectively. A BS may support one or multiple (e.g., three) cells.

The wireless network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

The wireless network 100 may be a heterogeneous network that includes BSs of different types, e.g., macro BS, pico BS, femto BS, relays, etc. These different types of BSs may have different transmit power levels, different coverage areas, and different impact on interference in the wireless network 100. For example, macro BS may have a high transmit power level (e.g., 20 Watts) whereas pico BS, femto BS, and relays may have a lower transmit power level (e.g., 1 Watt).

The wireless network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may be coupled to a set of BSs and provide coordination and control for these BSs. The network controller 130 may communicate with the BSs 110 via a backhaul. The BSs 110 may also communicate with one another, e.g., directly or indirectly via wireless or wireline backhaul.

The UEs 120 (e.g., 120x, 120y, etc.) may be dispersed throughout the wireless network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered evolved or machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices.

In FIG. 1, a solid line with double arrows indicates desired transmissions between a UE and a serving BS, which is a BS designated to serve the UE on the downlink and/or uplink. A dashed line with double arrows indicates interfering transmissions between a UE and a BS.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

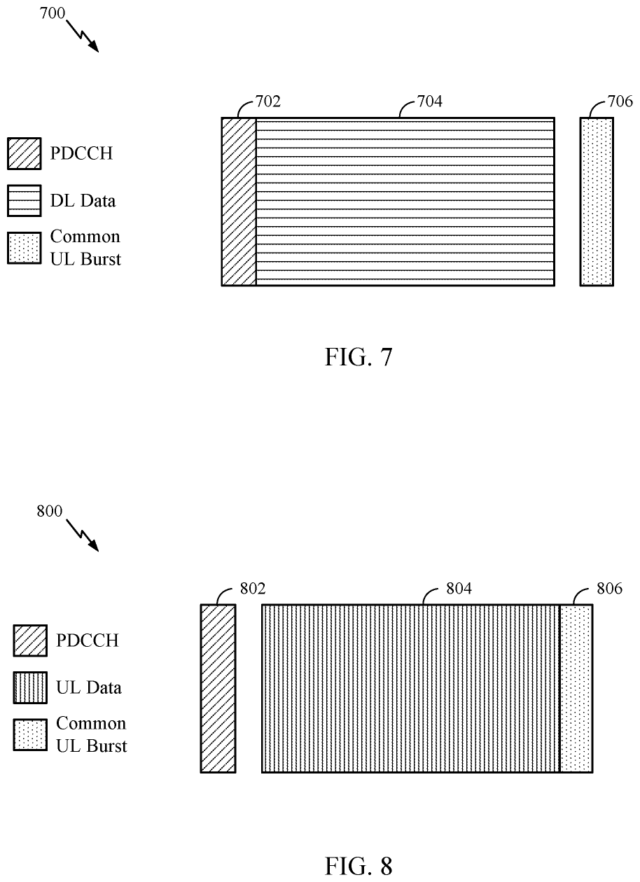

While aspects of the examples described herein may be associated with LTE technologies, aspects of the present disclosure may be applicable with other wireless communications systems, such as NR. NR may utilize OFDM with a CP on the uplink and downlink and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 ms duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 7 and 8. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based. NR networks may include entities such CUs and/or DUs.

In some examples, access to the air interface may be scheduled, wherein a scheduling entity (e.g., a base station) allocates resources for communication among some or all devices and equipment within its service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

As noted above, a RAN may include a CU and DUs. A NR BS (e.g., eNB, 5G Node B, Node B, transmission reception point (TRP), access point (AP)) may correspond to one or multiple BSs. NR cells can be configured as access cell (ACells) or data only cells (DCells). For example, the RAN (e.g., a central unit or distributed unit) can configure the cells. DCells may be cells used for carrier aggregation or dual connectivity, but not used for initial access, cell selection/reselection, or handover. In some cases DCells may not transmit synchronization signals—in some case cases DCells may transmit SS. NR BSs may transmit downlink signals to UEs indicating the cell type. Based on the cell type indication, the UE may communicate with the NR BS. For example, the UE may determine NR BSs to consider for cell selection, access, handover (HO), and/or measurement based on the indicated cell type.

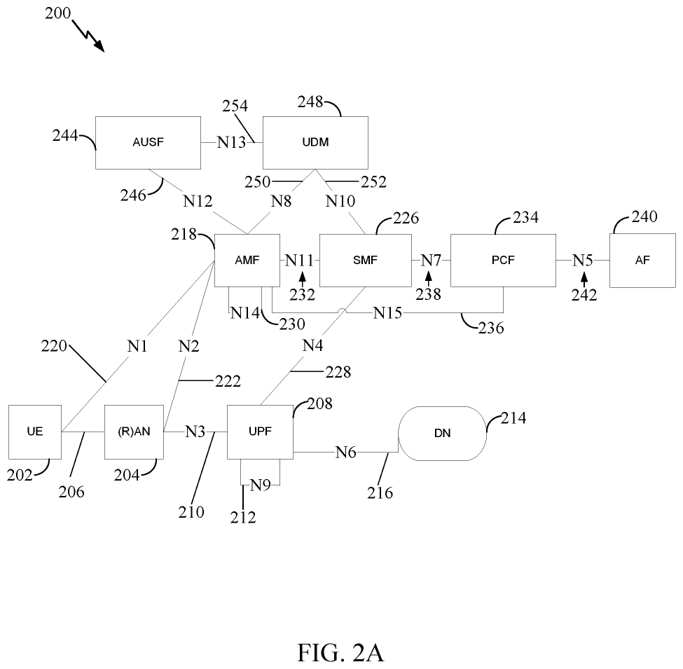

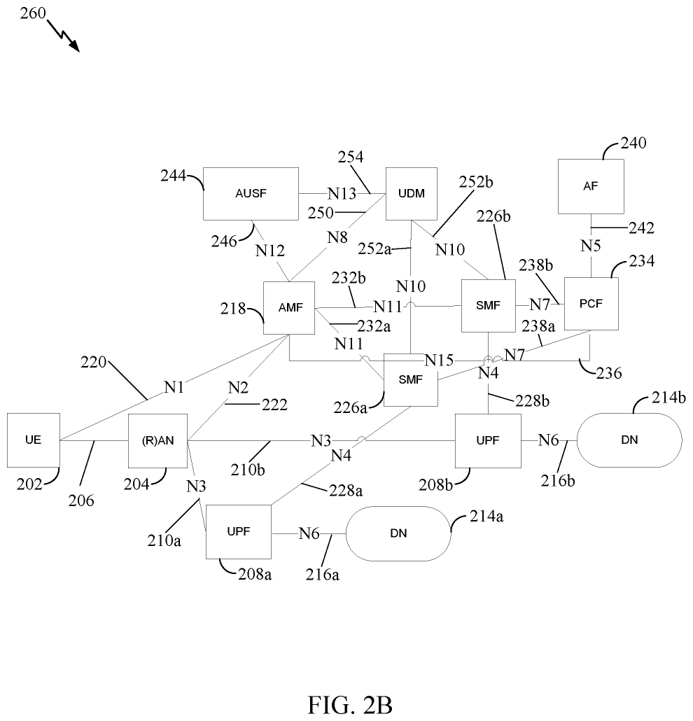

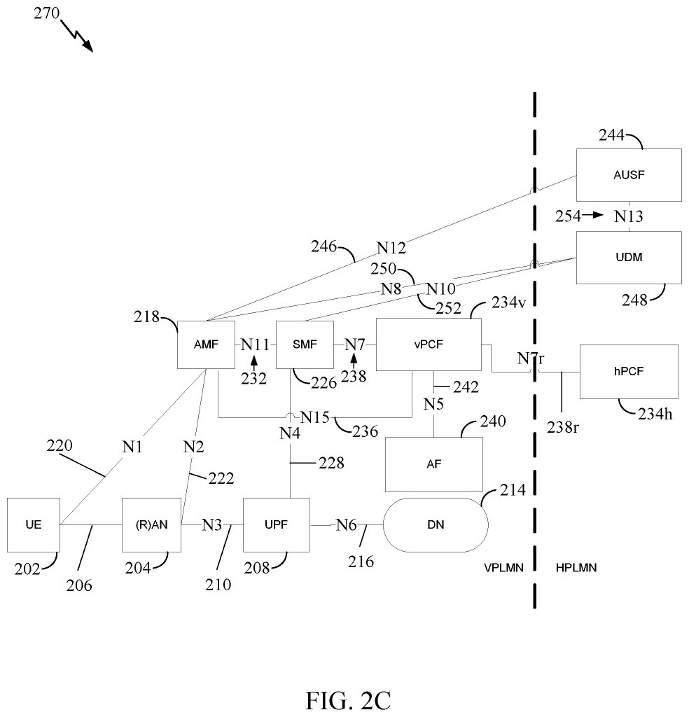

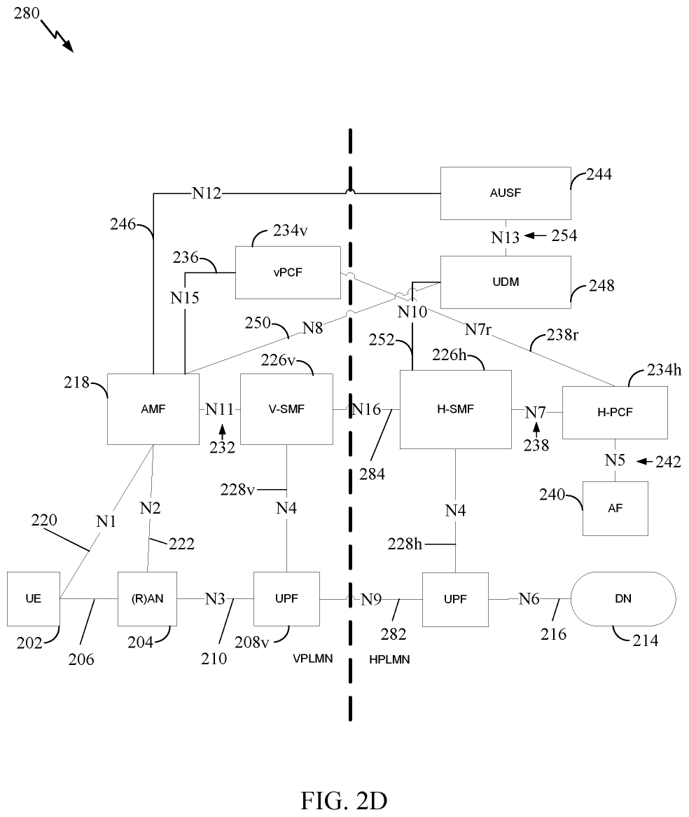

FIG. 2A illustrates an example logical architecture 200 of a New Radio (NR) access network, which may be implemented in the wireless communication system illustrated in FIG. 1. A UE 202 may access a radio access network (RAN) 204 via an NR air interface 206. The RAN may communicate with a user plane function (UPF) 208 via an N3 interface 210. Communications between different UPFs 208 may be conveyed via an N9 interface 212. The UPFs may communicate with a data network (DN) (e.g., the Internet, network-operator-provided services) 214 via one or more N6 interfaces 216. The UE may communicate with one or more core access and mobility management functions (AMFs) 218 via an N1 interface 220. The RAN may communicate with the one or more AMFs via an N2 interface 222. The UPFs may communicate with a session management function (SMF) 226 via an N4 interface 228.

Communications between different AMFs 218 may be conveyed via an N14 interface 230. The AMFs may communicate with the SMF 226 via an N11 interface 232. The AMFs may communicate with a policy control function (PCF) 234 via an N15 interface 236. The SMF may communicate with the PCF via an N7 interface 238. The PCF may communicate with an application function (AF) 240 via an N5 interface 242. The AMFs may communicate with an authentication server function (AUSF) 244 via an N12 interface 246. The AMFs may communicate with a unified data management (UDM) 248 via an N8 interface 250. The SMF may communicate with the UDM via an N10 interface 252. The AUSF may communicate with the UDM via an N13 interface 254.

While the example architecture 200 illustrates a single UE, the present disclosure is not so limited, and the architecture may accommodate any number of UEs. Similarly, the architecture shows the UE accessing a single DN, but the present disclosure is not so limited, and the architecture accommodates a UE communicating with a plurality of DNs, as described below with reference to FIG. 2B.

FIG. 2B illustrates an example logical architecture 260 of a New Radio (NR) access network (RAN), which may be implemented in the wireless communication system illustrated in FIG. 1. The logical architecture 250 is similar to the logical architecture 200 shown in FIG. 2A, with many of the same entities shown and labeled with the same labels. Thus, only differences from FIG. 2A will be described. The UE 202 in FIG. 2B is accessing two DNs, 214a and 214b, via the RAN 204. The RAN communicates with a first UPF 208a via a first N3 interface 210a. The RAN also communicates with a second UPF 208b via a second N3 interface 210b. Each UPF communicates with a corresponding DN 214a or 214b via a corresponding N6 interface 216a or 216b. Similarly, each UPF communicates with a corresponding SMF 226a or 226b via a corresponding N4 interface 228a or 228b. Each SMF communicates with the AMF 218 via a corresponding N11 interface 232a or 232b. Similarly, each SMF communicates with the PCF via a corresponding N7 interface 238a or 238b.

FIG. 2C illustrates an example logical architecture 270 of a New Radio (NR) access network (RAN), which may be implemented in the wireless communication system illustrated in FIG. 1. The logical architecture 270 is similar to the logical architecture 200 shown in FIG. 2A, with many of the same entities shown and labeled with the same labels. Thus, only differences from FIG. 2A will be described. In the logical architecture 270, the UE is roaming, and is therefore connected with the home physical land mobile network (HPLMN) of the UE via certain entities in the visited physical land mobile network (VPLMN). In particular, the SMF communicates with the VPLMN PCF (vPCF) 234v, but some policy information regarding the UE's access to the DN may be retrieved from the HPLMN PCF (hPCF) 234h via a roaming N7r interface 238r. In FIG. 2C, the UE is able to access the DN via the VPLMN.

FIG. 2D illustrates an example logical architecture 280 of a New Radio (NR) access network (RAN), which may be implemented in the wireless communication system illustrated in FIG. 1. The logical architecture 280 is similar to the logical architecture 270 shown in FIG. 2C, with many of the same entities shown and labeled with the same labels. Thus, only differences from FIG. 2C will be described. In the logical architecture 280, the UE is roaming, and is therefore connected with the home physical land mobile network (HIPLMN) of the UE via certain entities in the visited physical land mobile network (VPLMN). Unlike FIG. 2C, the UE in FIG. 2D is accessing a DN that the UE is not able to access via the VPLMN. Differences from FIG. 2C include that the UPF in the VPLMN communicates with the VPLMN SMF (V-SMF) 226v via an N4 interface 228v, while the UPF in the HPLMN communicates with the HPLMN SMF (H-SMF) 226h via an N4 interface 228h. The UPF of the VPLMN communicates with the UPF of the HPLMN via an N9 interface 282. Similarly, the V-SMF communicates with the H-SMF via an N16 interface 284.

Operations performed and protocols used by the various entities shown in the exemplary logical architectures 200, 250, 270, and 280 in FIGS. 2A-2D are described in more detail in documents “TS 23.501; System Architecture for the 5G System; Stage 2 (Release 15)” and “TS 23.502; Procedures for the 5G System; Stage 2 (Release 15),” both which are publicly available.

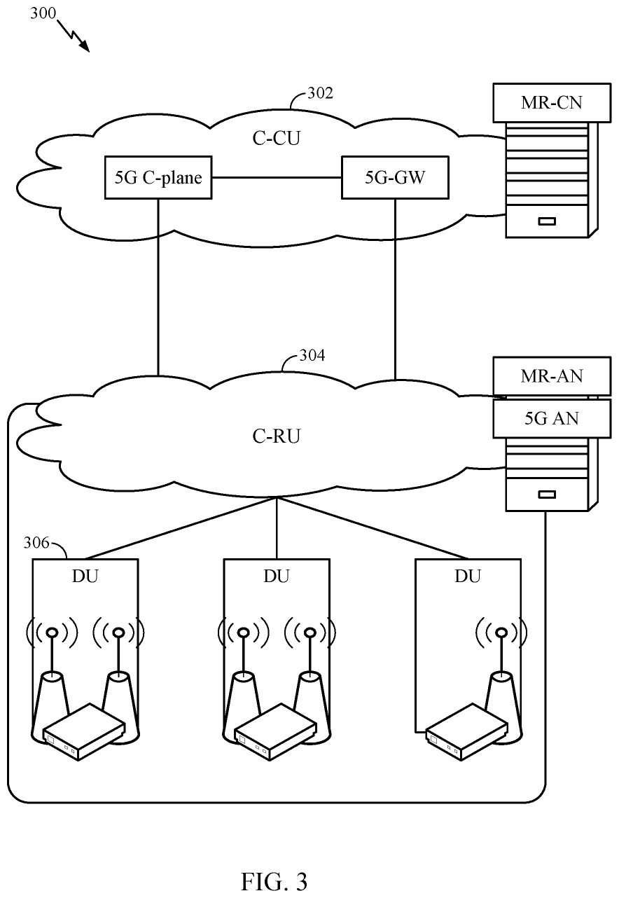

FIG. 3 illustrates an example physical architecture of a distributed RAN 300, according to aspects of the present disclosure. A centralized core network unit (C-CU) 302 may host core network functions. The C-CU may be centrally deployed. C-CU functionality may be offloaded (e.g., to advanced wireless services (AWS)), in an effort to handle peak capacity.

A centralized RAN unit (C-RU) 304 may host one or more access network controller (ANC) functions. Optionally, the C-RU may host core network functions locally. The C-RU may have distributed deployment. The C-RU may be closer to the network edge.

A data unit (DU) 306 may host one or more TRPs (edge node (EN), an edge unit (EU), a radio head (RH), a smart radio head (SRH), or the like). The DU may be located at edges of the network with radio frequency (RF) functionality.

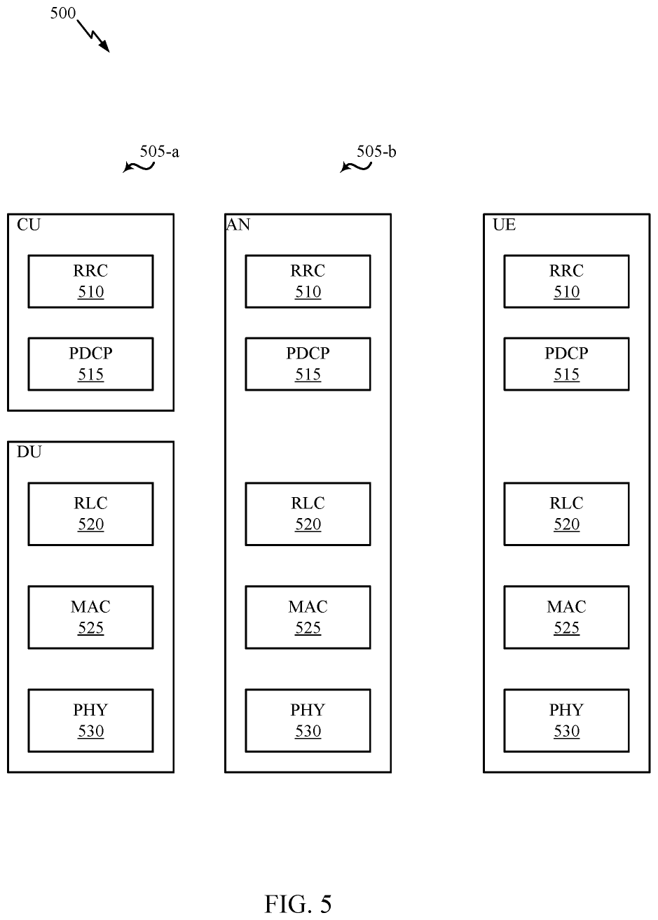

As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU or CU (e.g., TRP or ANC, respectively). According to certain aspects, a BS may include a central unit (CU) (e.g., C-CU 302) and/or one or more distributed units (e.g., one or more transmission and reception points (TRPs)).

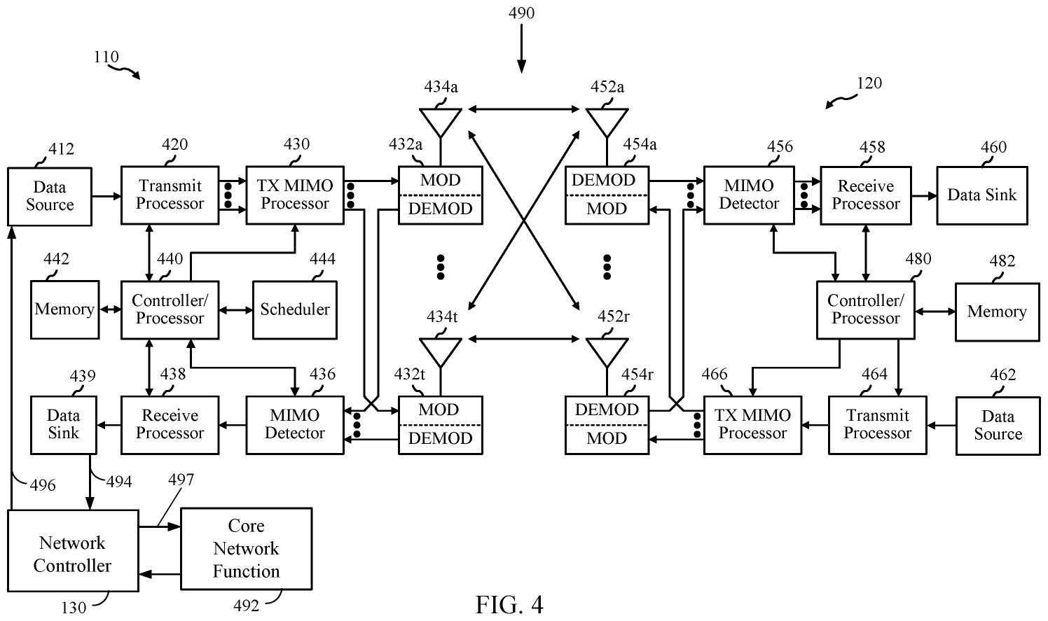

FIG. 4 illustrates example components of the BS 110 and UE 120 illustrated in FIG. 1, which may be used to implement aspects of the present disclosure. As described above, the BS may include a TRP. One or more components of the BS 110 and UE 120 may be used to practice aspects of the present disclosure. For example, antennas 452, Tx/Rx 222, processors 466, 458, 464, and/or controller/processor 480 of the UE 120 and/or antennas 434, processors 460, 420, 438, and/or controller/processor 440 of the BS 110 may be used to perform the operations described herein and illustrated with reference to FIGS. 11-12.

For example, a core network function 492 (e.g., an access and mobility management function (AMF)) may perform the operations of sending a request 490 for a location report of an aerial UE, and receiving the location report that includes height information of the UE, as described in more detail with reference to FIG. 11. In a complementary example, the BS 110 or a RAN (e.g., including the network controller 130 for receiving signals 494 and transmitting signals 496 with the BS 110) may perform the operations of receiving a request 490 (e.g., from an AMF) for a location report of a UE, and transmitting the location report 497 to the AMF, as described in more detail with reference to FIG. 12.

At the base station 110, a transmit processor 420 may receive data from a data source 412 and control information from a controller/processor 440. The control information may be for the Physical Broadcast Channel (PBCH), Physical Control Format Indicator Channel (PCFICH), Physical Hybrid ARQ Indicator Channel (PHICH), Physical Downlink Control Channel (PDCCH), etc. The data may be for the Physical Downlink Shared Channel (PDSCH), etc. The processor 420 may process (e.g., encode and symbol map) the data and control information to obtain data symbols and control symbols, respectively. The processor 420 may also generate reference symbols, e.g., for the PSS, SSS, and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. For example, the TX MIMO processor 430 may perform certain aspects described herein for RS multiplexing. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via antennas 434a through 434t, respectively.

At the UE 120, antennas 452a through 452r may receive the downlink signals from the base station 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. For example, MIMO detector 456 may provide detected RS transmitted using techniques described herein. A receive processor 458 may process (e.g., demodulate, deinterleave, and decode) the detected symbols, provide decoded data for the UE 120 to a data sink 460, and provide decoded control information to a controller/processor 480.

On the uplink, at the UE 120, a transmit processor 464 may receive and process data (e.g., for the Physical Uplink Shared Channel (PUSCH)) from a data source 462 and control information (e.g., for the Physical Uplink Control Channel (PUCCH) from the controller/processor 480. The transmit processor 464 may also generate reference symbols for a reference signal. The symbols from the transmit processor 464 may be precoded by a TX MIMO processor 466 if applicable, further processed by the demodulators 454a through 454r (e.g., for SC-FDM, etc.), and transmitted to the base station 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

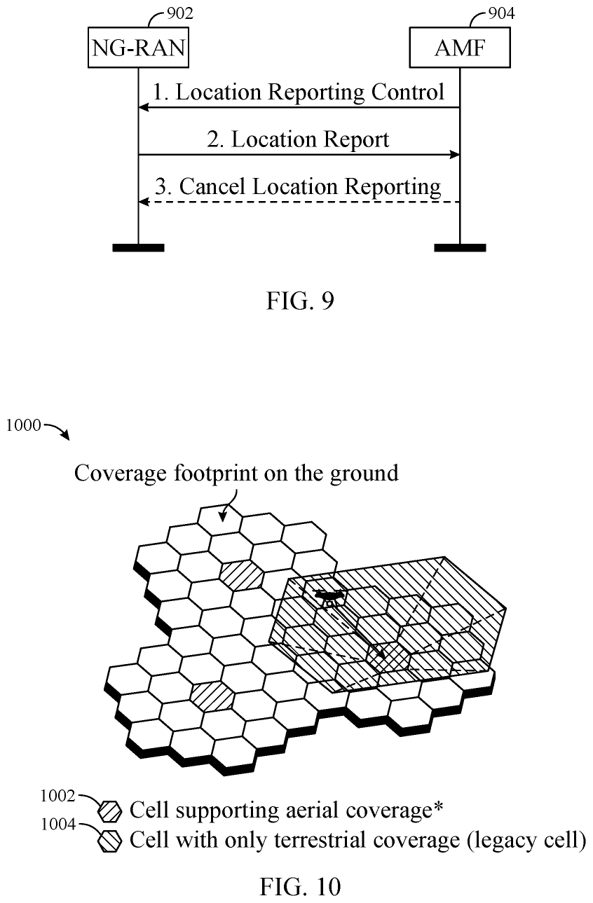

The controllers/processors 440 and 480 may direct the operation at the base station 110 and the UE 120, respectively. The processor 440 and/or other processors and modules at the base station 110 may perform or direct, e.g., the execution of the functional blocks illustrated in FIGS. 9-10, and/or other processes for the techniques described herein. The processor 480 and/or other processors and modules at the ULE 120 may also perform or direct processes for the techniques described herein. The memories 442 and 482 may store data and program codes for the BS 110 and the UE 120, respectively. A scheduler 444 may schedule UEs for data transmission on the downlink and/or uplink.

FIG. 5 illustrates a diagram 500 showing examples for implementing a communications protocol stack, according to aspects of the present disclosure. The illustrated communications protocol stacks may be implemented by devices operating in a in a 5G system (e.g., a system that supports uplink-based mobility). Diagram 500 illustrates a communications protocol stack including a Radio Resource Control (RRC) layer 510, a Packet Data Convergence Protocol (PDCP) layer 515, a Radio Link Control (RLC) layer 520, a Medium Access Control (MAC) layer 525, and a Physical (PHY) layer 530. In various examples the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device (e.g., access node (AN), new radio base station (NR BS), a new radio Node-B (NR NB), a network node (NN), or the like.). In the second option, the RRC layer 510, the PDCP layer 515, the RLC layer 520, the MAC layer 525, and the PHY layer 530 may reach be implemented by the AN. The second option 505-b may be useful in a femto cell deployment.

Regardless of whether a network access device implements part or all of a protocol stack, a UE may implement an entire protocol stack (e.g., the RRC layer 510, the PDCP layer 515, the RLC layer 520, the MAC layer 525, and the PHY layer 530).

Connection management (CM) comprises the functions of establishing and releasing a signaling connection between a UE (e.g., UE 202 in FIGS. 2A-2D) and the Access and Mobility Management Function (e.g., AMF 218 in FIGS. 2A-2D) over N1 (e.g., N1 interface 220 in FIGS. 2A-2D). This signaling connection is used to enable nonaccess stratum (NAS) signaling exchange between the UE and the core network. Connection management comprises both the access network (AN) signaling connection between the UE and the AN (e.g. radio resource control (RRC) connection over 3GPP access) and the N2 connection (e.g., N2 interface 222 in FIGS. 2A-2D) for this UE between the AN and the AMF.

In some embodiments, the UE may be in one of two CM states that reflect the NAS signaling connectivity of the UE with the AMF. The two CM states are CM-IDLE and CM-CONNECTED. In a CM-IDLE case, in some embodiments, the UE may have no NAS signaling connection established with the AMF over an N1 interface. In such embodiments, the UE may perform cell selection, cell reselection and public land mobile network (PLMN) selection. In addition, in such embodiments, there may be no N2 and N3 connections for the UE in the CM-IDLE state.

In the CM-IDLE state, the UE may perform one or more of the following actions. In some embodiments, the UE may respond to paging, if received, by performing a service request procedure. In some embodiments, the UE may perform a service request procedure when the UE has uplink signaling or user data to be sent. In some embodiments, the UE may enter the CM-CONNECTED state whenever an AN signaling connection is established between the UE and the AN (e.g. entering RRC Connected state over 3GPP access). The transmission of an Initial NAS message (Registration Request, Service Request or Deregistration Request) may initiate the transition from CM-IDLE to CM-CONNECTED state. In the CM-IDLE state, the AMF may also perform one or more of the following actions. In some embodiments, the AMF may perform a network triggered service request procedure when it has signaling or mobile-terminated data to be sent to this UE, by sending a Paging Request to this UE. In some embodiments, the AMF may enter CM-CONNECTED whenever an N2 connection is established for this UE between the AN and the AMF.

In the CM-CONNECTED state, the UE may have a NAS signaling connection with the AMF over N1. In the CM-CONNECTED state, in some embodiments, the UE may enter CM-IDLE state whenever the AN signaling connection is released (e.g., entering RRC Idle state over 3GPP access). In the CM-CONNECTED state, in some embodiments, the AMF may enter CM-IDLE state whenever the N2 signaling connection for this UE is released. In some embodiments, upon the completion of a NAS signaling procedure, the AMF may decide to release the NAS signaling connection with the UE, after which the state at both the UE and the AMF may be changed to CM-IDLE. In some embodiments, the AMF may keep a UE in CM-CONNECTED state until the UE de-registers from the core network.

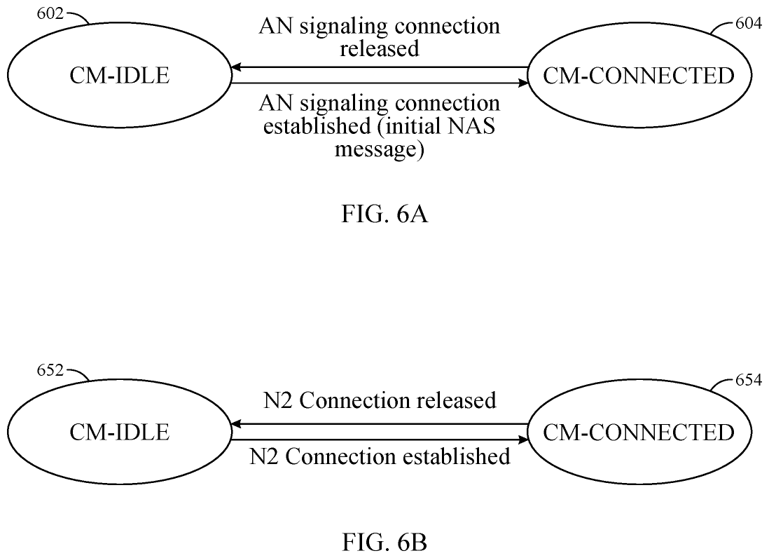

FIGS. 6A and 6B further illustrate example connection management state models. In FIG. 6A, transitions of a UE (e.g., UE 202 in FIGS. 2A-2D) between a CM-IDLE state 602 and a CM-CONNECTED state 604 are illustrated. In FIG. 6B, transitions of an AMF (e.g., AMF 218 in FIGS. 2A-2D) state with regard to a UE that transitions between a CM-IDLE state 652 and a CM-CONNECTE state 654 are illustrated. In some embodiments, when a UE becomes CM-IDLE over an access, the user plane (UP) connection of the PDU sessions that were active on the access may go inactive. In addition to the connection management states, certain embodiments described herein relate to NAS signaling connection management. In some embodiments, NAS signaling connection management may include the functions of establishing and releasing a NAS signaling connection. In regards to NAS signaling connection establishment, in some embodiments, an NAS signaling connection establishment function may be provided by the UE and the AMF to establish an NAS signaling connection for a UE in CM-IDLE state. In some embodiments, when the UE in the CM-IDLE state needs to transmit an NAS message, the UE may initiate a Service Request or a registration procedure to establish a signaling connection to the AMF.

Also, in some embodiments, based on UE preferences, UE subscription, UE mobility pattern and network configuration, the AMF may keep the NAS signaling connection until the UE de-registers from the network. In regards to NAS signaling connection release, in some embodiments, the procedure of releasing an NAS signaling connection is initiated by the 5G (R)AN node or the AMF. In some embodiments, the UE may assume the NAS signaling connection is released if it detects the RRC connection is released. After the NAS signaling connection is released, in some embodiments, the UE and the AMF may enter the CM-IDLE state.

System functionality may include registration and connection management. Registration management may be used to setup and release a signaling relation between the UE and the network and establish the user context in the network. More specifically, in some embodiments, a UE/user may need to register with the network to receive services that require registration. In some embodiments, to register to the selected PLMN, the UE may initiate an initial registration procedure. Also, in some embodiments, the UE may initiate a periodic registration procedure upon the expiry of the periodic registration timer in order to maintain reachability. In addition, in some embodiments, the UE may initiate a registration procedure upon mobility (e.g. enters new tracking area (TA)) with the network to track the UE location and for reachability.

In addition to registration management, system functionality may include connection management, which as described above, may be used to establish and release the signaling connection between the UE and the AMF to provide signaling connectivity. The 5GS Connection Management (CM) states, CM-IDLE and CM-CONNECTED, describe the signaling connectivity between the UE and the AMF.

A UE may be in a 5G CM-IDLE state when no NAS signaling connection between UE and AMF exists. In CM-IDLE state, in some embodiments, the UE may perform cell selection/reselection and PLMN selection. In addition, in some embodiments, the UE in the CM-IDLE state may respond to paging by performing a service request procedure and perform a service request procedure when the UE has uplink signaling or user data to be sent.

Unlike the CM-IDLE state, the UE and the AMF may enter the CM-CONNECTED state when the NAS signaling connection is established between the UE and the AMF. Initial NAS messages that initiate a transition from CM-IDLE to CM-CONNECTED state may, in some embodiments, include a Registration Request, Service Request or De-Registration Request. In some embodiments, the UE may be in the CM-CONNECTED state when a signaling connection between the UE and the AMF exists. In some embodiments, the UE in the CM-CONNECTED state may perform a registration procedure when the TA in the received system information is not in the list of TAs that the UE registered with the network.

In some embodiments, the UE may need to register with the network to be authorized to receive services, to enable mobility tracking, and to enable reachability. In some embodiments, the registration procedure may be used, for example, when the UE needs to initially register to the 5G system (in the mobility procedure when the UE changes to a new TA in idle mode) and when the UE performs a periodic update (due to a predefined time period of inactivity), etc.

As described above, 5G Systems may provide support for a UE to connect to a local area data network (LADN) reachable within a certain area. In order to enable a UE to connect to the LADN, the 5G system may send a notification to the UE including information about the LADN and its availability, etc. In some embodiments, based on the LADN information received in the notification, the UE may then request a PDU session establishment for the local area data network while the UE is located in the area.

FIG. 7 is a diagram 700 showing an example of a DL-centric subframe. The DL-centric subframe may include a control portion 702. The control portion 702 may exist in the initial or beginning portion of the DL-centric subframe. The control portion 702 may include various scheduling information and/or control information corresponding to various portions of the DL-centric subframe. In some configurations, the control portion 702 may be a physical DL control channel (PDCCH), as indicated in FIG. 7. The DL-centric subframe may also include a DL data portion 704. The DL data portion 704 may sometimes be referred to as the payload of the DL-centric subframe. The DL data portion 704 may include the communication resources utilized to communicate DL data from the scheduling entity (e.g., UE or BS) to the subordinate entity (e.g., UE). In some configurations, the DL data portion 704 may be a physical DL shared channel (PDSCH).

The DL-centric subframe may also include a common UL portion 706. The common UL portion 706 may sometimes be referred to as an UL burst, a common UL burst, and/or various other suitable terms. The common UL portion 706 may include feedback information corresponding to various other portions of the DL-centric subframe. For example, the common UL portion 706 may include feedback information corresponding to the control portion 702. Non-limiting examples of feedback information may include an ACK signal, a NACK signal, a HARQ indicator, and/or various other suitable types of information. The common UL portion 706 may include additional or alternative information, such as information pertaining to random access channel (RACH) procedures, scheduling requests (SRs), and various other suitable types of information. As illustrated in FIG. 7, the end of the DL data portion 704 may be separated in time from the beginning of the common UL portion 706. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 8 is a diagram 800 showing an example of an UL-centric subframe. The UL-centric subframe may include a control portion 802. The control portion 802 may exist in the initial or beginning portion of the UL-centric subframe. The control portion 802 in FIG. 8 may be similar to the control portion 702 described above with reference to FIG. 7. The UL-centric subframe may also include an UL data portion 804. The UL data portion 804 may sometimes be referred to as the payload of the UL-centric subframe. The UL portion may refer to the communication resources utilized to communicate UL data from the subordinate entity (e.g., UE) to the scheduling entity (e.g., UE or BS). In some configurations, the control portion 802 may be a physical DL control channel (PDCCH).

As illustrated in FIG. 8, the end of the control portion 802 may be separated in time from the beginning of the UL data portion 804. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 806. The common UL portion 806 in FIG. 8 may be similar to the common UL portion 706 described above with reference to FIG. 7. The common UL portion 806 may additional or alternative include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example NG-RAN Location Reporting Procedures and Enhancements for Arial Ues

FIG. 9 illustrates an example location reporting procedure, in accordance with certain aspects of the present disclosure. As shown, when a UE is in CM-CONNECTED state, the AMF 904 may request the NG-RAN node 902 to report where the UE is currently located. For example, at step 1, the AMF 904 configures location reporting control at the NG-RAN node 902. At step 2, the NG-RAN node 902 provides the location report as configured. In some cases, such as at step 3, the AMF 904 may cancel the location reporting. The location reporting procedure may be used for services that require accurate cell identification (such as emergency services, law enforcement activities, or the like), or for subscription to the service by other network functions.

To configure the location reporting, the “Location Reporting Request Type” information element (IE) may be used to indicate to the NG-RAN node 902 how to provide the location reporting. For example, the NG-RAN may be indicated regarding whether to report the location of the UE directly. In some cases, the IE may indicate whether the NG-RAN may report upon a change of the serving cell and/or the primary second cell group (SCG) cell (PSCell), when Dual Connectivity is activated for the UE. In some cases, the IE may indicate whether the NG-RAN may report UE presence in the area of interest. In some cases, the IE may indicate whether the NG-RAN may stop reporting at change of serving cell and PSCell, if Dual Connectivity is activated for the UE. In some cases, the IE may indicate whether the NG-RAN may stop reporting UE presence in the area of interest. In some cases, the IE may indicate whether the NG-RAN may cancel location reporting for the UE (e.g., step 3).

FIG. 10 illustrates example cells 1000, including cells 1002 supporting aerial coverage and cells 1004 not support aerial coverage, in accordance with certain aspects of the present disclosure. As shown, an aerial UE at certain altitude may be within coverage of a cell supporting aerial coverage while being located above another terrestrial cell that support only terrestrial coverage (e.g., a legacy cell).

Often, the location reporting is at cell-level or tracking area-level. For example, the location may be represented by a cell ID, at a cell-level resolution. That is, the location reporting level may be the area of interest (TAI) combined with the cell identity. Different reporting types may be used to indicate whether the message of location reporting is intended to trigger a single standalone report about the current cell ID serving the UE, start the NG-RAN to report whenever the UE changes cell, or ask the NG-RAN to report whenever the UE moves out or into an area of interest.

The areal coverage regions of a cell that supports aerial coverage (e.g., a cell in the sky) may be significantly different from the terrestrial coverage regions of cells that support only terrestrial coverage (e.g., legacy cells on the ground). As shown in FIG. 10, an aerial UE may connect to a side-lobe or up-tilted beam of a far-away cell that supports aerial coverage. A cell ID may be used for location representation because the cell ID is always available and does not require additional physical layer signaling. Although a cell ID may often be sufficient to provide an approximate location label, using a faraway cell's cell ID when the UE is an aerial UE would result in ambiguity that may lead to other errors (e.g., in various location services, emergency calls services, etc.). In the situation shown, using the cell ID of the serving cell may not represent the actual location of the aerial UE.

In such situations, the cell ID can be ambiguous and unreliable, for the location report of connected aerial UEs hovering in 3D-cells. For example, a temporary no-fly zone may be enforced in cell c, beyond height h. In the current setup, such no-fly zone cannot be defined as an area of interest. At present, an area of interest is defined in terms of tracking areas, a cell list (e.g., a list of cell IDs), or a RAN node list. In another example, location reporting may be set to be triggered by an event of cell change. When the aerial UE moves from cell c′ to c. The network may want to configure location reporting if the height is greater than h, because of the presence of the no-fly zone.

For at least the aforementioned reasons and use scenarios, including height information along with the existing location reporting procedure is desired. Aspects of the present disclosure provides one or more options for including such high information in the location reporting procedures. In some cases, the height information may be defined with a height-interval list for a three-dimensional location reporting. In some cases, the height information may be defined by a three-dimensional area of interest. In some cases, the height information may be associated with new event types that may cause an update of the location reporting procedure, such as when a change of the height of the UE becomes above or below a preconfigured threshold. These options may be combined and/or modified based on requirements in specific use cases.

FIG. 11 illustrates example operations 1100 for wireless communications, in accordance with aspects of the present disclosure. Operations 1100 may be performed by a first network entity, such as a core network entity having a control plane function (e.g., an access and mobility management function (AMF), such as the AMF 218 shown in FIGS. 2A-2D).

Operations 1100 begin, at 1102, by transmitting, to a second network entity, a request for a location report of a UE. For example, the second network entity may include an access network entity, such as NG-RAN. The request for the location report is transmitted when the UE is in a CM connected state (e.g., the CM-CONNECTE state 654 of FIGS. 6A-6B).

At 1104, operations 1100 continue with the first network entity receiving, from the second network entity, the location report including height information of the UE. The second network entity may include a RAN identifiable by a cell identifier (ID). The location report may include the cell ID of the RAN.

FIG. 12 illustrates example operations 1200 for wireless communications, in accordance with aspects of the present disclosure. Operations 1200 may be performed by a second network entity (e.g., a radio access network (RAN) device of a network, such as BS 120 shown in FIG. 1, and/or a DU, such as DU 306 shown in FIG. 3). Operations 1200 may be complementary to operations 1100 of FIG. 11.

Operations 1200 begin, at 1202, by receiving, from a first network entity, a request for a location report of a UE. The first network entity may be a core network entity having a control plane function, such as an AMF. The location report is transmitted when the UE is in a CM connected state.

At 1204, the second network entity transmits, to the first network entity, the location report including height information of the UE.

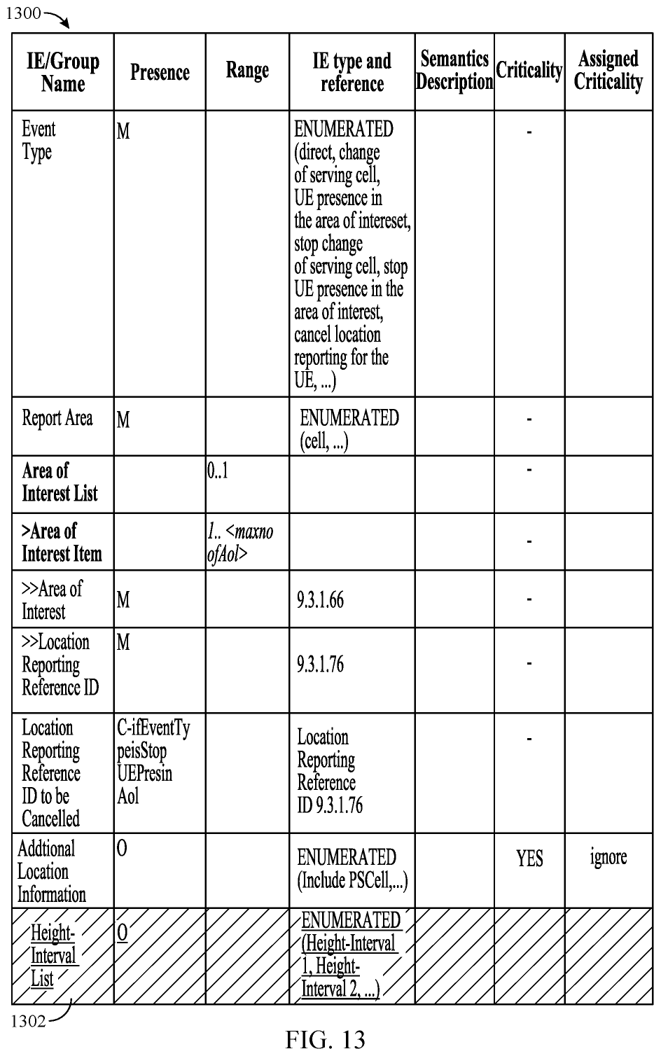

According to aspects of the present disclosure, the height information of the location report includes a value for identifying a height of the UE from a list of height intervals. In some cases, the first network entity may receive an update of the height information when a change of the second network entity occurs (e.g., when the UE experiences handover from one RAN to another). FIG. 13 illustrates an example information element 1300 for location reporting with height information. As shown, a height-interval list 1302 is included in the location request to be handled by the second network entity (e.g., NG-RAN node).

The height-interval list 1302 may include an enumerated list of height values or brackets (H₁, H₂, . . . , Hₙ), in which a measurement height of the UE may fall. For example, H₁ may indicate any height of the UE that is below H₁. H₂ may indicate a height of the UE that falls between H₁ and H₂ (not including H₂), and so on. Hₙ may indicate an end measurement height that indicates the height of the UE exceeding the height of Hₙ₋₁. In some cases, the height interval may be considered as the measurement resolution or accuracy achievable or required by the wireless communication system.

During reporting, the second network entity may use height-interval identifiers (IDs) corresponding to the values or indices of the height-interval. In some cases, the height-interval IDs may be reported in cases of both one-time location reporting and continuous location reporting. In one-time location reporting, the second network entity may report the current UE location (e.g., the cell ID of the second network entity) and the height-interval ID that represents the height of the UE. In continuous location reporting, the second network entity may report any change to the UE location and/or height information occurs. For example, the second network entity may report the location upon any change of height of the UE in any cell served by the NG-RAN (e.g., upon change of serving cell, reporting height together, or upon change of height (in any cell served by the NG-RAN)).

In some cases, the first network entity may receive an update of the height information when the height of the UE in the list of height intervals has changed. For example, when the UE is an aerial UE, such as a drone, UAV, flying car, aerial vehicles in general, or a device within (including handheld device carried onboard), traveling at different heights or altitudes may be sufficient for a location report update.

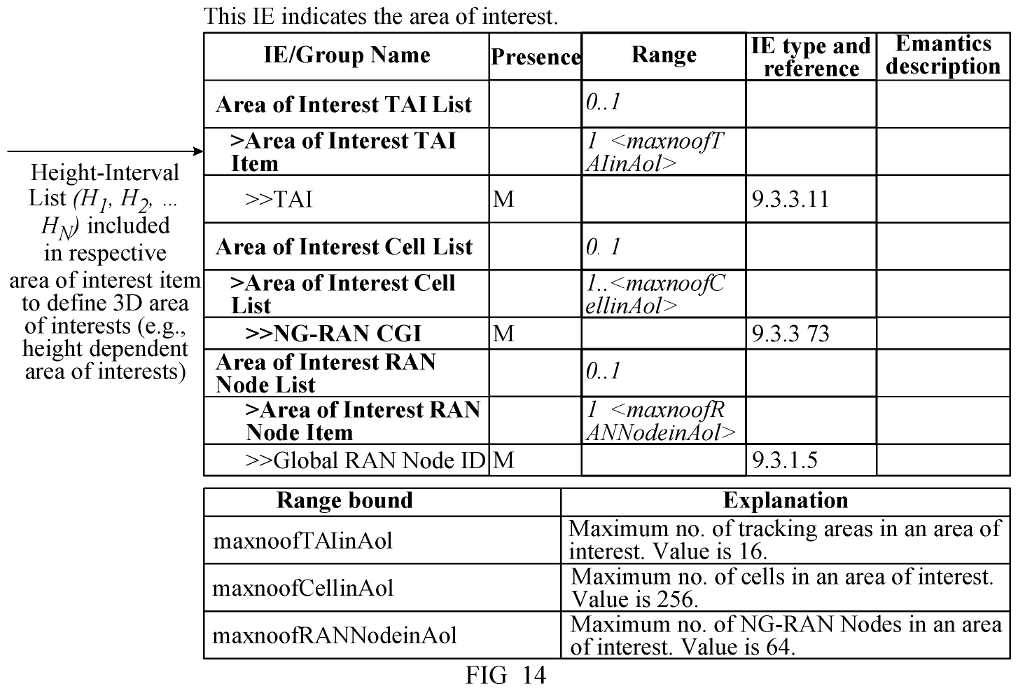

According to aspects of the present disclosure, the height information of the UE may include a three-dimensional area of interest defined by an index of an area and an index of a height interval. For example, the index of the area may correspond to the cell identifier of the second network entity. FIG. 14 illustrates an example information element for an area of interest. As shown, the three-dimensional area of interest may be height dependent when a height-interval list is defined therein. FIG. 14 illustrates where the height-interval list may be defined. In the example height interval list (H₁, H₂, . . . , H_{N}), H₁ may indicate a height below H₁. Hⱼ refers to heights in the interval Hⱼ₋₁ and Hⱼ. H_{N} refers to height over H_{N}, where N>j.

The tracking area identity (TAI) of the area of interest (and other aspects of the information element) may be similarly extended to include the height information. Examples of other aspects of the information element may include the area of interest cell, area of interest RAN node items, Area of Interest-3D TAI, Area of Interest-3D Cell, among others. For example, the area of interest-3D RAN node items may be reported using an ordered pair (i, j), where i is the index of the legacy 2D area of interest and j∈(1, 2, . . . , N) is the index or ID of the height interval.

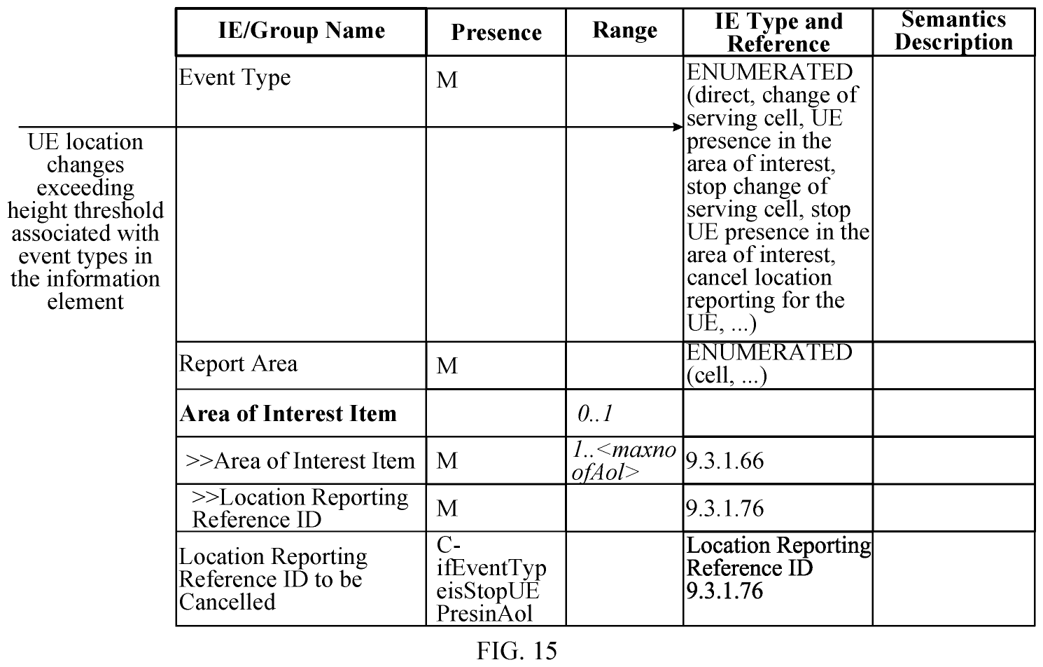

According to aspects of the present disclosure, the height information of the UE may be associated with one or more event types, such as new event types based on height information updates. For example, the one or more event types may indicate a change of height in an area of interest above or below a preconfigured threshold. In some cases, the one or more event types may further include indications of at least one of: a change of serving cell, an area of interest, or a cancellation of the location report. The one or more new event types may be modified from, or added to Location Reporting Request Type. FIG. 15 illustrates an example information element for an event type associated with height information. The “Location Reporting Request Type” information element indicates the type of location request to be handled by the NG-RAN node.

As shown in FIG. 15, height threshold values may be added to associate with the information element event types and references, such that when the UE location changes exceeds the threshold in during events as defined, the NG-RAN node may update the location reporting. Such an event type (and other event types) associated with the height of the UE may be defined. For example, the new event type (e.g., entering or exiting a 3D area of interest) may be based on a change of UE height above or below a preconfigured threshold.

### Example Wireless Communication Devices

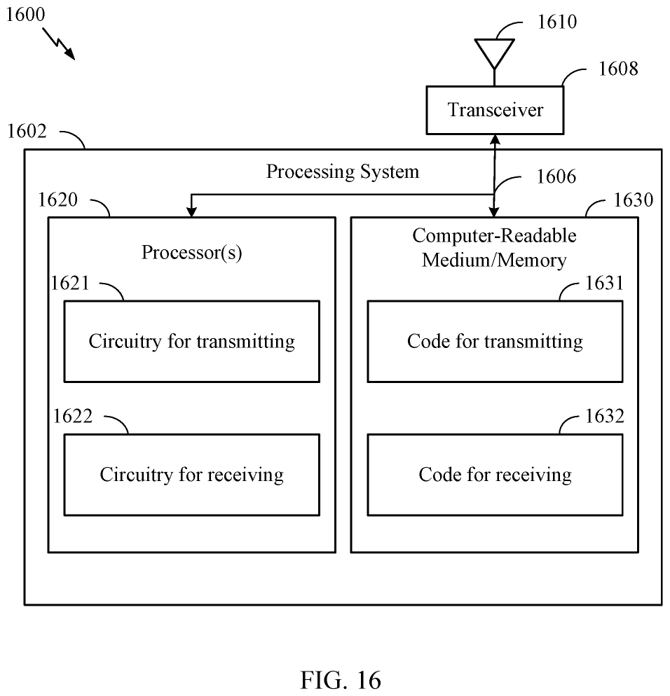

FIG. 16 depicts an example communications device 1600 that includes various components operable, configured, or adapted to perform operations for the techniques disclosed herein, such as the operations depicted and described with respect to FIG. 11. In some examples, the example communication device 1600 may be a first network entity, such as the core network 170, AMF 218 or 904, or core network function 492 as described, for example with respect to FIGS. 1, 2A-2D, 4 and 9.

The communications device 1600 includes a processing system 1602 coupled to a transceiver 1608 (e.g., a transmitter and/or a receiver). Transceiver 1608 is configured to transmit (or send) and receive signals for the communications device 1600 via an antenna 1610, such as the various signals as described herein. Processing system 1602 may be configured to perform processing functions for communications device 1600, including processing signals received and/or to be transmitted by communications device 1600.

Processing system 1602 includes one or more processors 1620 coupled to a computer-readable medium/memory 1630 via a bus 1606. In certain aspects, computer-readable medium/memory 1630 is configured to store instructions (e.g., computer-executable code) that when executed by the one or more processors 1620, cause the one or more processors 1620 to perform the operations illustrated in FIG. 11, or other operations for performing the various techniques discussed herein for exchanging TRP information.

In the depicted example, computer-readable medium/memory 1630 stores code 1631 for transmitting, and code 1632 for receiving.

In the depicted example, the one or more processors 1620 include circuitry configured to implement the code stored in the computer-readable medium/memory 1630, including circuitry 1621 for transmitting, and circuitry 1622 for receiving.

Various components of communications device 1600 may provide means for performing the methods described herein, including with respect to FIG. 11.

In some examples, means for transmitting or sending (or means for outputting for transmission) may include the transceivers 232 and/or antenna(s) 234 of the base station 102 illustrated in FIG. 2 and/or transceiver 1608 and antenna 1610 of the communication device 1600 in FIG. 16.

In some examples, means for receiving (or means for obtaining/acquiring) may include the transceivers 232 and/or antenna(s) 234 of the base station illustrated in FIG. 2 and/or transceiver 1608 and antenna 1610 of the communication device 1600 in FIG. 16.

In some examples, means for determining and/or detecting may include various processing system components, such as: the one or more processors 1620 in FIG. 16, or aspects of the base station 102 depicted in FIG. 2, including receive processor 238, transmit processor 220, TX MIMO processor 230, and/or controller/processor 240.

Notably, FIG. 16 is an example, and many other examples and configurations of communication device 1600 are possible.

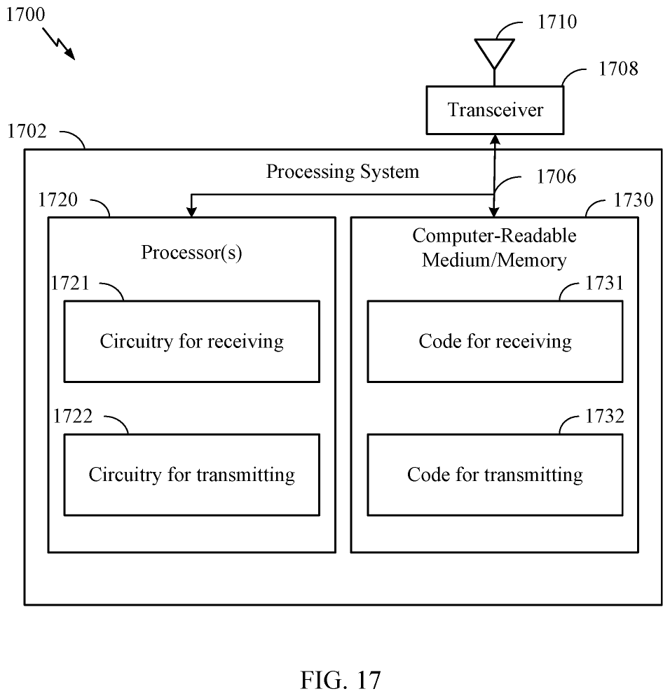

FIG. 17 depicts an example communications device 1600 that includes various components operable, configured, or adapted to perform operations for the techniques disclosed herein, such as the operations depicted and described with respect to FIG. 12. In some examples, communication device 1600 may be a second network entity, such as the base station 102 connected to the access network controller 130, the RAN 204, or the NG-RAN 902 as described, for example with respect to FIGS. 1, 2A-2D, 4 and 9.

Communications device 1600 includes a processing system 1602 coupled to a transceiver 1608 (e.g., a transmitter and/or a receiver). Transceiver 1608 is configured to transmit (or send) and receive signals for the communications device 1600 via an antenna 1610, such as the various signals as described herein. Processing system 1602 may be configured to perform processing functions for communications device 1600, including processing signals received and/or to be transmitted by communications device 1600.

Processing system 1602 includes one or more processors 1620 coupled to a computer-readable medium/memory 1630 via a bus 1606. In certain aspects, computer-readable medium/memory 1630 is configured to store instructions (e.g., computer-executable code) that when executed by the one or more processors 1620, cause the one or more processors 1620 to perform the operations illustrated in FIG. 12, or other operations for performing the various techniques discussed herein for exchanging TRP information.

In the depicted example, computer-readable medium/memory 1630 stores code 1631 for receiving, and code 1732 for transmitting.

In the depicted example, the one or more processors 1620 include circuitry configured to implement the code stored in the computer-readable medium/memory 1630, including circuitry 1621 for identifying, and circuitry 1622 for transmitting.

Various components of communications device 1600 may provide means for performing the methods described herein, including with respect to FIG. 12.

In some examples, means for transmitting or sending (or means for outputting for transmission) may include the transceivers 232 and/or antenna(s) 234 of the base station 102 illustrated in FIG. 2 and/or transceiver 1608 and antenna 1610 of the communication device 1600 in FIG. 16.

In some examples, means for receiving (or means for obtaining/acquiring) may include the transceivers 232 and/or antenna(s) 234 of the base station illustrated in FIG. 2 and/or transceiver 1608 and antenna 1610 of the communication device 1600 in FIG. 16.

In some examples, means for determining and/or computing may include various processing system components, such as: the one or more processors 1620 in FIG. 16, or aspects of the base station 102 depicted in FIG. 2, including receive processor 238, transmit processor 220, TX MIMO processor 230, and/or controller/processor 240.

Notably, FIG. 16 is an example, and many other examples and configurations of communication device 1600 are possible.

### EXAMPLE CLAUSES

Implementation examples are described in the following numbered clauses:

Clause 1: A method for wireless communications by a first network entity, comprising: transmitting, to a second network entity, a request for a location report of a user equipment (UE); and receiving, from the second network entity, the location report including height information of the UE.

Clause 2: The method of Clause 1, wherein the first network entity comprises a core network entity having a control plane function, wherein the second network entity comprises an access network entity, and wherein the request for the location report is transmitted when the UE is in a connection management (CM) connected state.

Clause 3: The method of Clause 2, wherein the control plane function comprises an access and mobility management function (AMF).

Clause 4: The method of any one of Clauses 1 to 3, wherein the second network entity comprises a radio access network (RAN) identifiable by a cell identifier (ID).

Clause 5: The method of Clause 4, wherein the location report further includes the cell ID of the RAN.

Clause 6: The method of any one of Clauses 1 to 5, wherein the height information of the UE comprises a value for identifying a height of the UE from a list of height intervals.

Clause 7: The method of Clause 6, further comprising: receiving an update of the height information when a change of the second network entity occurs.

Clause 8: The method of Clause 6, further comprising: receiving an update of the height information when the height of the UE in the list of height intervals has changed.

Clause 9: The method of any one of Clauses 1 to 8, wherein the height information of the UE comprises a three-dimensional area of interest defined by an index of an area and an index of a height interval.

Clause 10: The method of Clause 9, wherein the index of the area corresponds to a cell identifier of the second network entity.

Clause 11: The method of any one of Clauses 1 to 10, wherein the height information of the UE is associated with one or more event types.

Clause 12: The method of Clause 11, wherein the one or more event types indicate a change of height in an area of interest above or below a preconfigured threshold.

Clause 13: The method of Clause 12, wherein the one or more event types further include indications of at least one of: a change of serving cell, an area of interest, or a cancellation of the location report.

Clause 14: A method for wireless communications by a second network entity, comprising: receiving, from a first network entity, a request for a location report of a user equipment (UE); and transmitting, to the first network entity, the location report including height information of the UE.

Clause 15: The method of Clause 14, wherein the first network entity comprises a core network entity having a control plane function, wherein the second network entity comprises an access network entity, and wherein the request for the location report is transmitted when the UE is in a connection management (CM) connected state.

Clause 16: The method of Clause 15, wherein the control plane function comprises an access and mobility management function (AMF).

Clause 17: The method of any one of Clauses 14 to 16, wherein the second network entity comprises a radio access network (RAN) identifiable by a cell identifier (ID).

Clause 18: The method of Clause 17, wherein the location report further includes the cell ID of the RAN.

Clause 19: The method of any one of Clauses 14 to 18, wherein the height information of the UE comprises a value for identifying a height of the UE from a list of height intervals.

Clause 20: The method of Clause 19, further comprising: transmitting an update of the height information when a change of the second network entity occurs.

Clause 21: The method of Clause 19, further comprising: transmitting an update of the height information when the height of the UE in the list of height intervals has changed.

Clause 22: The method of any one of Clauses 14 to 21, wherein the height information of the UE comprises a three-dimensional area of interest defined by an index of an area and an index of a height interval.

Clause 23: The method of Clause 22, wherein the index of the area corresponds to a cell identifier of the second network entity.

Clause 24: The method of any one of Clauses 14 to 23, wherein the height information of the UE is associated with one or more event types.

Clause 25: The method of Clause 24, wherein the one or more event types indicate a change of height in an area of interest above or below a preconfigured threshold.

Clause 26: The method of Clause 25, wherein the one or more event types further include indications of at least one of: a change of serving cell, an area of interest, or a cancellation of the location report.

Clause 27: A processing system, comprising: a memory comprising computer-executable instructions; one or more processors configured to execute the computer-executable instructions and cause the processing system to perform a method in accordance with any one of Clauses 1-26.

Clause 28: A processing system, comprising means for performing a method in accordance with any one of Clauses 1-26.

Clause 29: A non-transitory computer-readable medium comprising computer-executable instructions that, when executed by one or more processors of a processing system, cause the processing system to perform a method in accordance with any one of Clauses 1-26.

Clause 30: A computer program product embodied on a computer-readable storage medium comprising code for performing a method in accordance with any one of Clauses 1-26.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting and/or means for receiving may comprise one or more of a transmit processor 420, a TX MIMO processor 430, a receive processor 438, or antenna(s) 434 of the base station 110 and/or the transmit processor 464, a TX MIMO processor 466, a receive processor 458, or antenna(s) 452 of the user equipment 120. Additionally, means for generating, means for multiplexing, and/or means for applying may comprise one or more processors, such as the controller/processor 440 of the base station 110 and/or the controller/processor 480 of the user equipment 120.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, the instructions may include instructions for performing the operations described herein and illustrated in FIGS. 11-12.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a first network entity, comprising:
transmitting, to a second network entity, a request for a location report of a user equipment (UE); and
receiving, from the second network entity, the location report including height information of the UE.

2. The method of claim 1, wherein the first network entity comprises a core network entity having a control plane function, wherein the second network entity comprises an access network entity, and wherein the request for the location report is transmitted when the UE is in a connection management (CM) connected state.

3. The method of claim 2, wherein the control plane function comprises an access and mobility management function (AMF).

4. The method of claim 1, wherein the second network entity comprises a radio access network (RAN) identifiable by a cell identifier (ID).

5. The method of claim 4, wherein the location report further includes the cell ID of the RAN.

6. The method of claim 1, wherein the height information of the UE comprises a value for identifying a height of the UE from a list of height intervals.

7. The method of claim 6, further comprising:
receiving an update of the height information when a change of the second network entity occurs.

8. The method of claim 6, further comprising:
receiving an update of the height information when the height of the UE in the list of height intervals has changed.

9. The method of claim 1, wherein the height information of the UE comprises a three-dimensional area of interest defined by an index of an area and an index of a height interval.

10. The method of claim 9, wherein the index of the area corresponds to a cell identifier of the second network entity.

11. The method of claim 1, wherein the height information of the UE is associated with one or more event types.

12. The method of claim 11, wherein the one or more event types indicate a change of height in an area of interest above or below a preconfigured threshold.

13. The method of claim 12, wherein the one or more event types further include indications of at least one of: a change of serving cell, an area of interest, or a cancellation of the location report.

14. A method for wireless communications by a second network entity, comprising:
receiving, from a first network entity, a request for a location report of a user equipment (UE); and
transmitting, to the first network entity, the location report including height information of the UE.

15. The method of claim 14, wherein the first network entity comprises a core network entity having a control plane function, wherein the second network entity comprises an access network entity, and wherein the request for the location report is transmitted when the UE is in a connection management (CM) connected state.

16. The method of claim 15, wherein the control plane function comprises an access and mobility management function (AMF).

17. The method of claim 14, wherein the second network entity comprises a radio access network (RAN) identifiable by a cell identifier (ID).

18. The method of claim 17, wherein the location report further includes the cell ID of the RAN.

19. The method of claim 14, wherein the height information of the UE comprises a value for identifying a height of the UE from a list of height intervals.

20. The method of claim 19, further comprising:
transmitting an update of the height information when a change of the second network entity occurs.

21. The method of claim 19, further comprising:
transmitting an update of the height information when the height of the UE in the list of height intervals has changed.

22. The method of claim 14, wherein the height information of the UE comprises a three-dimensional area of interest defined by an index of an area and an index of a height interval.

23. The method of claim 22, wherein the index of the area corresponds to a cell identifier of the second network entity.

24. The method of claim 14, wherein the height information of the UE is associated with one or more event types.

25. The method of claim 24, wherein the one or more event types indicate a change of height in an area of interest above or below a preconfigured threshold.

26. The method of claim 25, wherein the one or more event types further include indications of at least one of: a change of serving cell, an area of interest, or a cancellation of the location report.

27. A first network entity comprising:
a memory; and
a processor coupled to the memory, the processor and the memory configured to:
transmit, to a second network entity, a request for a location report of a user equipment (UE); and
receive, from the second network entity, the location report including height information of the UE.

28. The first network entity of claim 27, wherein the first network entity comprises a core network entity having a control plane function, wherein the second network entity comprises an access network entity, and wherein the request for the location report is transmitted when the UE is in a connection management (CM) connected state.

29. The first network entity of claim 28, wherein the control plane function comprises an access and mobility management function (AMF).

30. A second network entity comprising:
means for receiving, from a first network entity, a request for a location report of a user equipment (UE); and
means for transmitting, to the first network entity, the location report including height information of the UE.
